(19) United States
(12) Patent Application Publication
(10) Pub. No.: US 2004/0092622 A1
(43) Pub. Date: May 13, 2004

(54) Inkjet ink with reduced bronzing

(76) Inventors: Kathryn Amy Pearlstine, Chadds Ford, PA (US); Lauri L. Jenkins, Newark, DE (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/607,378

(22) Filed: Jun. 26, 2003

Related U.S. Application Data
(60) Provisional application No. 60/393,198, filed on Jul. 1, 2002.

(51) Int. Cl. C03C 17/00; C09D 5/00; C08K 5/34

(52) U.S. Cl. 523/160; 523/161; 524/88

(57) ABSTRACT

This invention pertains to an aqueous inkjet ink based on a cyan copper phthalocyanine pigment dispersed in an aqueous vehicle and, more particularly, to the use of polyurethanes to reduce bronzing in the printed ink typically associated with this pigment.

### CROSS-REFERENCE TO RELATED APPLICATION

This application claims priority under 35 U.S.C. §119 from U.S. Provisional Application Serial No. 60/393,198 (filed Jul. 1, 2002), which is incorporated by reference herein as if fully set forth.

### BACKGROUND OF THE INVENTION

This invention pertains to an inkjet ink comprising cyan copper phthalocyanine pigment and, more particularly, to the reduction of bronzing typically associated with this pigment.

Inkjet recording is a printing method wherein droplets of ink are ejected through fine nozzles to form letters or figures on the surface of recording media. Inks used in such recording are subject to rigorous demands including, for example, good dispersion stability, ejection stability, and good fixation to media.

Both dyes and pigments have been used as colorants for inkjet inks. While dyes typically offer superior color properties compared to pigments, they tend to fade quickly and are more prone to rub off. Inks comprising pigments dispersed in aqueous media are advantageously superior to inks using water-soluble dyes in water-fastness and light-fastness of printed images.

An inkjet ink set for color printing typically comprises cyan, magenta and yellow colorants. When the colorants are pigments, the cyan pigment of choice is almost always a copper phthalocyanine (CuPc). Although advantageous in many ways, CuPc cyan pigments are known to show an undesirable “bronzing” effect (red or pink reflection from the printed surface) in the printed ink. See, for example, EP-A1-1203797 (incorporated by reference herein for all purposes as if fully set forth).

It is an object of this invention to provide a cyan inkjet ink which displays little or no bronzing in the printed ink.

### SUMMARY OF THE INVENTION

It was found that inclusion of a polyurethane dispersion in an aqueous cyan ink containing a CuPc pigment can substantially reduce or eliminate the appearance of bronzing in the printed ink. In addition, the polyurethane dispersion was also found to increase optical density and improve gloss uniformity in the printed ink.

In accordance with this finding, the present invention pertains to an aqueous inkjet ink comprising an aqueous vehicle having dispersed therein (1) a cyan copper phthalocyanine pigment and (2) a polyurethane.

The present invention also pertains to an aqueous inkjet ink comprising a mixture of (1) an aqueous vehicle, (2) a cyan copper phthalocyanine pigment and (3) a polyurethane dispersion, such that the pigment and polyurethane are dispersed in the aqueous vehicle.

In another aspect, the present invention pertains to an inkjet ink set for color printing, comprising a cyan, magenta and yellow ink, wherein, the cyan ink is an aqueous inkjet ink as set forth above.

In another aspect, the present invention pertains to an improved aqueous inkjet ink comprising an aqueous vehicle having dispersed therein a cyan copper phthalocyanine pigment, wherein the improvement comprises that said aqueous ink jet ink further comprises an effective amount of a polyurethane dispersed in said aqueous vehicle.

In another aspect, the present invention pertains to an improved inkjet ink set for color printing, wherein the inkjet set comprises a cyan, magenta and yellow ink, and wherein the improvement comprises that the cyan ink is an aqueous inkjet ink comprising an aqueous vehicle having dispersed therein a cyan copper phthalocyanine pigment and an effective amount of a polyurethane.

In still another aspect, the present invention pertains to a method of reducing bronzing in a printed ink wherein the ink (prior to printing) is an aqueous inkjet ink comprising an aqueous vehicle having dispersed therein a cyan copper phthalocyanine pigment, wherein said method comprises the step of providing in said aqueous inkjet ink an effective amount of a polyurethane dispersed in said aqueous vehicle.

In an embodiment of the aforementioned, the cyan copper phthalocyanine pigment is not dispersed in the aqueous vehicle by a sodium aromaticsulfonate-formaldehyde condensate dispersant, and/or the weight ratio of cyan copper phthalocyanine pigment to polyurethane is less than about 2.5.

As used above and otherwise herein, an “effective amount” of a polyurethane dispersed in the aqueous medium (or a polyurethane dispersion) is an amount required to achieve a reduction in bronzing in the printed ink as compared to the use of an aqueous inkjet ink without the dispersed polyurethane. The choice of polyurethane and the effective amount needed to reduce bronzing is readily determined for each ink as provided for herein.

These and other features and advantages of the present invention will be more readily understood by those of ordinary skill in the art from a reading of the following detailed description. It is to be appreciated that certain features of the invention which are, for clarity, described above and below in the context of separate embodiments, may also be provided in combination in a single embodiment. Conversely, various features of the invention which are, for brevity, described in the context of a single embodiment, may also be provided separately or in any subcombination. In addition, references to in the singular may also include the plural (for example, “a” and “an” may refer to one, or one or more) unless the context specifically states otherwise.

### DETAILED DESCRIPTION OF THE PREFERRED EMBODIMENTS

CuPc Pigments

The CuPc may be pigments such as PB 15:3 and 15:4. Examples of some commercially available materials are given in the following table.

| C. I. No. | Vendor | Trade Name |
|---|---|---|
| PB 15:3 | Aztech | Chemisperse ® Cyan CC1531 |
| PB 15:3 | Bayer | Bayplast ® EPFG |
| PB 15:3 | CIBA | Irgalite ® GLG |
| PB 15:3 | CIBA | Irgalite ® LGLD |
| PB 15:3 | Clariant | Hostaperm ® B2G |
| PB 15:3 | Clariant | Novatex ® BGW |
| PB 15:3 | Toyo Pigments | Lionel ® Blue FG-7990 |
| PB 15:4 | Aztech | Chemisperse ® Cyan CC1541 |
| PB 15:4 | Aztech | Chemisperse ® Cyan CC1542 |
| PB 15:4 | BASE | Heliogen ® D 7160 TD |
| PB 15:4 | BASE | Heliogen ® K7100 |
| PB 15:4 | BASE | Heliogen ® L7101F |
| PB 15:4 | Clariant | Hostaperm ® BT-617-D |
| PB 15:4 | Daicolor-Pope | Chromofine ® DC3150 |
| PB 15:4 | Daicolor-Pope | Chromofine ® DC3160 |
| PB 15:4 | Kish/Delta | (none) |
| PB 15:4 | Lenape | Blue B-8800 |
| PB 15:4 | Sun Chemical | Spectra PAC ® W Blue |
| PB 15:4 | Sun Chemical | Sunfast ® Blue 249-0592 |
| PB 15:4 | Sun Chemical | Sunfast ® Blue 249-8450 |
| PB 15:4 | Toyo Pigments | Lionel ® Blue FG-7400-G |
| PB 15:3 | Daicolor-Pope | Chromofine ® DC3127 |
| PB 15:4 | Bayer | Palomar ® EB-8592 |

Traditionally, pigments are stabilized to dispersion in a vehicle by dispersing agents, such as polymeric dispersants or surfactants. More recently though, so-called “self-dispersible” or “self-dispersing” pigments (hereafter “SDP”) have been developed. As the name would imply, SDPs are dispersible in water, or aqueous vehicle, without dispersants. The cyan pigment particles of this invention may be stabilized to dispersion by surface treatment to be self-dispersing (see, for example, WO01/94476, which is incorporated by reference herein for all purposes as if fully set forth), by treatment with dispersant in the traditional way, or by some combination of surface treatment and dispersant.

Preferably, when dispersant is employed, the dispersant(s) is a random or structured polymeric dispersant. Preferred random polymers include acrylic polymer and styrene-acrylic polymers. Most preferred are structured dispersants which include AB, BAB and ABC block copolymers, branched polymers and graft polymers. Some useful structured polymers are disclosed in U.S. Pat. No. 5,085,698, EP-A-0556649 and U.S. Pat. No. 5,231,131, which are incorporated by reference herein for all purposes as if fully set forth.

Preferably, when the copper phthalocyanine pigment is dispersant stabilized, the dispersant is other than sodium aromatic sulfonate-formaldehyde condensate dispersant.

Useful particle size is typically in the range of from about 0.005 micron to about 15 micron. Preferably, the pigment particle size should range from about 0.005 to about 5 micron, more preferably from about 0.005 to about 1 micron, and most preferably from about 0.005 to about 0.3 micron.

Polyurethane Dispersions (PUDs)

In accordance with the present invention the term “polyurethane dispersion” refers to aqueous dispersions of polymers containing urethane groups and optionally urea groups, as that term is understood by those of ordinary skill in the art. These polymers also incorporate hydrophilic functionality to the extent required to maintain a stable dispersion of the polymer in water.

Preferred polyurethane dispersions are those in which the polymer is predominantly stabilized in the dispersion through incorporated ionic functionality, and particularly anionic functionality such as neutralized acid groups (“anionically stabilized polyurethane dispersion”). Further details are provided below.

Such aqueous polyurethane dispersions are typically prepared by a multi-step process in which an NCO prepolymer is initially formed and subsequently chain extended in the aqueous phase optionally in the presence of a polyfunctional group chain extender. Also, the NCO prepolymer is typically formed by a multi-step process.

Typically, in the first stage of prepolymer formation, a diisocyanate is reacted with a compound containing one or more isocyanate-reactive groups and at least one acid or acid salt group to form an intermediate product. The molar ratio of diisocyanate to compounds containing isocyanate-reactive groups is such that the equivalents of isocyanate functionality is greater than the equivalents of isocyanate-reactive functionality, resulting in an intermediate product terminated by at least one NCO group. Thus, the molar ratio of diisocyanate to compounds containing one isocyanate-reactive group is at least about 1:1, preferably about 1:1 to about 2:1, more preferably about 1:1 to about 1.5:1 and most preferably about 1:1. The molar ratio of diisocyanate to compounds containing two isocyanate-reactive groups is at least about 1:5:1, preferably about 1.5:1 to about 3:1, more preferably about 1.8:1 to about 2.5:1, and most preferably about 2:1. Ratios for mixtures of compounds containing one and two isocyanate-reactive groups can readily be determined depending on the ratio of the two.

In general, the various ratios ensure that at least one of the isocyanate-reactive groups of the compounds containing acid groups are reacted with isocyanate groups, preferably most of the isocyanate-reactive groups are reacted with isocyanate groups from the diisocyanate.

After the preparation of the previously described intermediate product, the remaining components are reacted with the intermediate product to form the NCO prepolymer. These other components include a high molecular weight polyol, optionally an isocyanate-reactive compound containing non-ionic hydrophilic groups, optionally a low molecular weight, isocyanate-reactive chain extender, and optionally an isocyanate-reactive compound containing non-ionic groups which can self condense to form a crosslink. These components are reacted in amounts sufficient to provide a molar ratio such that the overall equivalent ratio of isocyanate groups to isocyanate-reactive groups is about 1.1:1 to about 2:1, preferably about 1.2:1 to about 1.8:1, and more preferably about 1.2:1 to about 1.5:1.

Suitable diisocyanates for reacting with the isocyanate-reactive compound containing ionic groups (or groups which can be rendered ionic via, for example, neutralization) are those which contain either aromatic, cycloaliphatic or aliphatic-bound isocyanate groups. The preferred isocyanate is bound to a cycloaliphatic or aliphatic group.

Examples of suitable diisocyanates include cyclohexane-1,3- and -1,4-diisocyanate; 1-isocyanato-3-isocyanatomethyl-3,5,5-trimethyl-cyclohexane (isophorone diisocyanate or IPDI); bis-(4-isocyanatocyclohexyl)-methane; 1,3- and 1,4-bis-(isocyanatomethyl)-cyclohexane; 1-isocyanato-2-isocyanatomethyl cyclopentane; bis-(4-isocyanatocyclohexyl)-methane; 2,4′-diisocyanato-dicyclohexyl methane; bis-(4-isocyanato-3-methyl-cyclohexyl)-methane, alpha,alpha,alpha′,alpha′-tetramethyl-1,3- and/or -1,4-xylylene diisocyanate; 1-isocyanato-1-methyl-4(3)-isocyanatomethyl cyclohexane; and 2,4- and/or 2,6-hexahydrotoluylene diisocyanate.

Additional diisocyanates may be linear or branched and contain 4 to 12 carbon atoms, preferably 4 to 8 carbon atoms and more preferably 6 carbon atoms, which include 1,4-tetramethylene diisocyanate; 1,6-hexamethylene diisocyanate; 2,2,4-trimethyl-1,6-hexamethylene diisocyanate; and 1,12-dodecamethylene diisocyanate. 1,6-hexamethylene diisocyanate is especially preferred. Also preferred is isophorone diisocyanate.

Isocyanate-reactive compounds containing acid groups, i.e., carboxylic acid groups, carboxylate groups, sulphonic acid groups, sulphonate groups, phosphoric acid groups and phosphonate groups, are chemically incorporated into the polyurethane to provide hydrophilicity and enable the polyurethane to be stably dispersed in an aqueous medium. The acid salts are formed by neutralizing the corresponding acid groups either prior to, during or after formation of the NCO prepolymer, preferably after formation of the NCO prepolymer. Isocyanate-reactive compounds containing carboxylic acids or carboxylic acid salts are preferred.

Suitable compounds for incorporating carboxyl groups are described in U.S. Pat. Nos. 3,479,310, 4,108,814 and 4,408,008, which are incorporated by reference herein for all purposes as if fully set forth. The neutralizing agents for converting the carboxylic acid groups to carboxylate salt groups are described in the preceding U.S. patents and are also discussed hereinafter. Within the context of this invention, the term “neutralizing agents” is meant to embrace all types of agents which are useful for converting carboxylic acid groups to hydrophilic carboxylate salt groups.

Preferred carboxylic group-containing compounds are the hydroxy-carboxylic acids corresponding to the formula (HO)ₓQ(COOH)_{y} wherein Q represents a straight or branched, hydrocarbon radical containing 1 to 12 carbon atoms, x is 1 or 2, preferably 2 and y is 1 to 3, preferably 1 or 2 and more preferably 1.

Examples of these hydroxy-carboxylic acids include citric acid, tartaric acid and hydroxypivalic acid.

Especially preferred acids are those of the above-mentioned formula wherein x=2 and y=1. These dihydroxy alkanoic acids are described in U.S. Pat. No. 3,412,054, which is incorporated by reference herein for all purposes as if fully set forth. Especially preferred dihydroxy alkanoic acids are the alpha,alpha-dimethylol alkanoic acids represented by the structural formula:

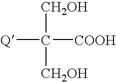

wherein Q′ is hydrogen or an alkyl group containing 1 to 8 carbon atoms. The most preferred compound is alpha,alpha-dimethylol propionic acid, i.e., wherein Q′ is methyl in the above formula.

The acid groups are incorporated in an amount sufficient to provide an ionic group content of at least about 200, and preferably at least about 1000, milliequivalents per 100 g of polyurethane. The upper limit for the content of acid groups is generally about 2500, and preferably about 1800 milliequivalents per 100 g of polyurethane.

After reaction of the diisocyanates with the isocyanate-reactive compounds containing acid groups, the resulting intermediate product is reacted with a high molecular weight polyol to prepare the prepolymer.

Suitable higher molecular weight polyols containing at least two hydroxy groups, which may be reacted with the preadducts to prepare the NCO prepolymers, are those having a molecular weight of about 400 to about 6000, preferably about 800 to about 3000, and more preferably about 1000 to about 2500. The molecular weights are number average molecular weights (Mn) and are determined by end group analysis (OH number). Examples of these high molecular weight compounds include polyester polyols, polyether polyols, polyhydroxy polycarbonates, polyhydroxy polyacetals, polyhydroxy polyacrylates, polyhydroxy polyester amides and polyhydroxy polythioethers. A combination of the polyols can also be used in the polyurethane. The polyester-polyols, polyether polyols and polyhydroxy polycarbonates are preferred.

Suitable polyester polyols include reaction products of polyhydric, preferably dihydric alcohols to which trihydric alcohols may be added and polybasic, preferably dibasic carboxylic acids. Instead of these polycarboxylic acids, the corresponding carboxylic acid anhydrides or polycarboxylic acid esters of lower alcohols or mixtures thereof may be used for preparing the polyesters. The polycarboxylic acids may be aliphatic, cycloaliphatic, aromatic and/or heterocyclic and they may be substituted, for example, by halogen atoms, and/or unsaturated. The following are mentioned as examples: succinic acid; adipic acid; suberic acid; azelaic acid; sebacic acid; phthalic acid; isophthalic acid; trimellitic acid; phthalic acid anhydride; tetrahydrophthalic acid anhydride; hexahydrophthalic acid anhydride; tetrachlorophthalic acid an hydride; endomethylene tetrahydrophthalic acid anhydride; glutaric acid anhydride; maleic acid; maleic acid anhydride; fumaric acid; dimeric and trimeric fatty acids such as oleic acid, which may be mixed with monomeric fatty acids; dimethyl terephthalates and bis-glycol terephthalate. Suitable polyhydric alcohols include, e.g., ethylene glycol; propylene glycol-(1, 2) and -(1,3); butylene glycol-(1,4) and -(1,3); hexanediol-(1,6); octanediol-(1,8); neopentyl glycol; cyclohexanedimethanol (1,4-bis-hydroxymethyl-cyclohexane); 2-methyl-1,3-propanediol; 2,2,4-trimethyl-1, 3-pentanediol; triethylene glycol; tetraethylene glycol; polyethylene glycol; dipropylene glycol; polypropylene glycol; dibutylene glycol and polybutylene glycol, glycerine and trimethylol-propane. The polyesters may also contain a portion of carboxyl end groups. Polyesters of lactones, for example, epsilon-caprolactone, or hydroxycarboxylic acids, for example, omega-hydroxycaproic acid, may also be used.

Polycarbonates containing hydroxyl groups include those known, per se, such as the products obtained from the reaction of diols such as propanediol(1,3), butanediol-(1,4) and/or hexanediol-(1,6), diethylene glycol, triethylene glycol or tetraethylene glycol with phosgene, diarylcarbonates such as diphenylcarbonate or with cyclic carbonates such as ethylene or propylene carbonate. Also suitable are polyester carbonates obtained from the above-mentioned polyesters or polylactones with phosgene, diaryl carbonates or cyclic carbonates.

Suitable polyether polyols are obtained in known manner by the reaction of starting compounds which contain reactive hydrogen atoms with alkylene oxides such as ethylene oxide, propylene oxide, butylene oxide, styrene oxide, tetrahydrofuran, epichlorohydrin or mixtures of these alkylene oxides. It is preferred that the polyethers do not contain more than about 10% by weight of ethylene oxide units. Most preferably, polyethers obtained without the addition of ethylene oxide are used. Suitable starting compounds containing reactive hydrogen atoms include the polyhydric alcohols set forth for preparing the polyester polyols and, in addition, water, methanol, ethanol, 1,2,6-hexane triol, 1,2,4-butane triol, trimethylol ethane, pentaerythritol, mannitol, sorbitol, methyl glycoside, sucrose, phenol, isononyl phenol, resorcinol, hydroquinone, 1,1,1- or 1,1,2-tris-(hydroxylphenyl)ethane.

Polyethers that have been obtained by the reaction of starting compounds containing amine compounds can also be used, but are less preferred for use in the present invention. Examples of these polyethers as well as suitable polyhydroxy polyacetals, polyhydroxy polyacrylates, polyhydroxy polyester amides, polyhydroxy polyamides and polyhydroxy polythioethers are disclosed in U.S. Pat. No. 4,701,480, which is incorporated by reference herein for all purposes as if fully set forth.

Poly(meth)acrylates containing hydroxyl groups include those common in the art of addition polymerization such as cationic, anionic and radical, polymerization and the like. Preferred are alpha-omega diols. An example of these type of diols are those which are prepared by a “living” or “control” or chain transfer polymerization processes which enables the placement of one hydroxyl group at or near the termini of the polymer. U.S. Pat. Nos. 6,248,839 and 5,990,245 (both incorporated by reference herein for all purposes as if fully set forth) have examples of protocol for making terminal diols.

The high molecular weight polyols are generally present in the polyurethanes in an amount of at least about 5%, preferably at least about 10% by weight, based on the weight of the polyurethane. The maximum amount of these polyols is generally about 85%, and preferably about 75% by weight, based on the weight of the polyurethane.

Other optional compounds for preparing the NCO prepolymer include low molecular weight, at least difunctional isocyanate-reactive compounds having an average molecular weight of up to about 400. Examples include the dihydric and higher functionality alcohols, which have previously been described for the preparation of the polyester polyols and polyether polyols.

In addition to the above-mentioned components which are preferably difunctional in the isocyanate polyaddition reaction, mono-functional and even small portions of trifunctional and higher functional components generally known in polyurethane chemistry, such as trimethylolpropane or 4-isocyanantomethyl-1,8-octamethylene diisocyanate, may be used in special cases in which slight branching of the NCO prepolymer or polyurethane is desired. However, the NCO prepolymers should be substantially linear and this may be achieved by maintaining the average functionality of the prepolymer starting components at or below 2.1.

Other optional compounds include isocyanate-reactive compounds containing lateral or terminal, hydrophilic ethylene oxide units. The content of hydrophilic ethylene oxide units (when present) may be up to about 10%, preferably up to about 8%, more preferably about 1 to about 6% and most preferably about 2 to about 6%, by weight, based on the weight of the polyurethane. In addition, up to about 75% of the allowable, chemically incorporated, hydrophilic ethylene oxide units may be replaced by the known nonionic, external emulsifiers such as those of the alkaryl type such as polyoxyethylene nonyl phenyl ether or polyoxyethylene octyl phenyl ether; those of the alkyl ether type such as polyoxyethylene lauryl ether or polyoxyethylene oleyl ether; those of the alkyl ester type such as polyoxyethylene laurate, polyoxyethylene oleate or polyoxyethylene stearate; and those of the polyoxyethylene benzylated phenyl ether type.

The isocyanate-reactive compounds for incorporating lateral or terminal, hydrophilic ethylene oxide units may contain either one or two isocyanate-reactive groups, preferably hydroxy groups. Examples of these compounds are disclosed in U.S. Pat. Nos. 3,905,929, 3,920,598 and 4,190,566, which are incorporated by reference herein for all purposes as if fully set forth. Preferred hydrophilic components are the monohydroxy polyethers having terminal hydrophilic chains containing ethylene oxide units. These hydrophilic components may be produced as described in the preceding patents by alkoxylating a monofunctional starter, such as methanol or n-butanol, using ethylene oxide and optionally another alkylene oxide, such as propylene oxide.

Other optional compounds include isocyanate-reactive compounds containing self-condensing moieties. The content of these compounds are dependent upon the desired level of self-condensation necessary to provide the desirable resin properties. 3-amino-1-triethoxysilyl-propane is an examples on a compound that will react with isocyanates through the amino group and yet self-condense through the silyl group when inverted into water.

Non-condensable silanes with isocyanate reactive groups can be used in place of or in conjunction with the include isocyanate-reactive compounds containing self-condensing moieties. U.S. Pat. Nos. 5,760,123 and 6,046,295 (both incorporated by reference herein for all purposes as if fully set forth) are exemplary methods for use of these optional silane containing compounds.

Process conditions for preparing the NCO prepolymers have been discussed in the patents previously incorporated by reference. The finished NCO prepolymer should have a free isocyanate content of about 1 to about 20%, preferably about 1 to about 10% by weight, based on the weight of prepolymer solids.

The polyurethanes are typical prepared by chain extending these NCO prepolymers. Preferred chain extenders are polyamine chain extenders, which can optionally be partially or wholly blocked as disclosed in U.S. Pat. No. 4,269,748 and 4,829,122, which are incorporated by reference herein for all purposes as if fully set forth. These patents disclose the preparation of aqueous polyurethane dispersions by mixing NCO prepolymers with at least partially blocked, diamine or hydrazine chain extenders in the absence of water and then adding the mixture to water. Upon contact with water the blocking agent is released and the resulting unblocked polyamine reacts with the NCO prepolymer to form the polyurethane.

Suitable blocked amines and hydrazines include the reaction products of polyamines with ketones and aldehydes to form ketimines and aldimines, and the reaction of hydrazine with ketones and aldehydes to form ketazines, aldazines, ketone hydrazones and aldehyde hydrazones. The at least partially blocked polyamines contain at most one primary or secondary amino group and at least one blocked primary or secondary amino group which releases a free primary or secondary amino group in the presence of water.

Suitable polyamines for preparing the at least partially blocked polyamines have an average functionality, i.e., the number of amine nitrogens per molecule, of 2 to 6, preferably 2 to 4 and more preferably 2 to 3. The desired functionalities can be obtained by using mixtures of polyamines containing primary or secondary amino groups. The polyamines are generally aromatic, aliphatic or alicyclic amines and contain between 1 to 30, preferably 2 to 15 and more preferably 2 to 10 carbon atoms. These polyamines may contain additional substituents provided that they are not as reactive with isocyanate groups as the primary or secondary amines. These same polyamines can be partially or wholly blocked polyamines.

Preferred polyamines include 1-amino-3-aminomethyl-3,5,5-trimethylcyclohexane (isophorone diamine or IPDA), bis-(4-amino-cyclohexyl)-methane, bis-(4-amino-3-methylcyclohexyl)-methane, 1,6-diaminohexane, ethylene diamine, diethylene triamine, triethylene tetramine, tetraethylene pentamine and pentaethylene hexamine. Hydrazine is also preferred.

The amount of chain extender to be used in accordance with the present invention is dependent upon the number of terminal isocyanate groups in the prepolymer. Preferably, the ratio of terminal isocyanate groups of the prepolymer to isocyanate-reactive groups of the chain extender is between about 1.0:0.6 and about 1.0:1.1, more preferably between about 1.0:0.8 and about 1.0:0.98, on an equivalent basis. Any isocyanate groups that are not chain extended with an amine will react with water, which functions as a diamine chain extender.

Chain extension can take place prior to addition of water in the process, but typically takes place by combining the NCO prepolymer, chain extender, water and other optional components under agitation.

In order to have a stable dispersion, a sufficient amount of the acid groups must be neutralized so that, when combined with the optional hydrophilic ethylene oxide units and optional external emulsifiers, the resulting polyurethane will remain stably dispersed in the aqueous medium. Generally, at least about 75%, preferably at least about 90%, of the acid groups are neutralized to the corresponding carboxylate salt groups.

Suitable neutralizing agents for converting the acid groups to salt groups either before, during or after their incorporation into the NCO prepolymers, include tertiary amines, alkali metal cations and ammonia. Examples of these neutralizing agents are disclosed in U.S. Pat. Nos. 4,501,852 and 4,7014,80, both of which are incorporated by reference herein for all purposes as if fully set forth. Preferred neutralizing agents are the trialkyl-substituted tertiary amines, such as triethyl amine, tripropyl amine, dimethylcyclohexyl amine, and dimethylethyl amine.

Neutralization may take place at any point in the process. A typical procedures include at least some neutralization of the prepolymer, which is then chain extended in water in the presence of additional neutralizing agent.

Further details about the preparation of polyurethane dispersions can be found from the previously incorporated references.

The final product is a stable aqueous dispersion of polyurethane particles having a solids content of up to about 60% by weight, preferably about 15 to about 60% by weight and most preferably about 30 to about 45% by weight. However, it is always possible to dilute the dispersions to any minimum solids content desired.

Suitable polyurethane aqueous dispersions are commercially available from numerous commercial sources, for example, under the trade names Bayhydrol® from Bayer AG, Hybridur® from Air Products and Chemicals, Cydrothane® from Cytec Industries, Inc., Macekote from Mace Adhesives and Coatings Co., Inc, and Sancure® from B. F. Goodrich Co.

Aqueous Vehicle

The aqueous vehicle is water or a mixture of water and at least one water-soluble organic solvent. Selection of a suitable mixture depends on requirements of the specific application, such as desired surface tension and viscosity, the selected colorant, drying time of the ink, and the type of substrate onto which the ink will be printed. Representative examples of water-soluble organic solvents that may be selected are disclosed in U.S. Pat. No. 5,085,698 (incorporated by reference herein for all purposes as if fully set forth).

If a mixture of water and a water-soluble solvent is used, the aqueous vehicle typically will contain about 30% to about 95% water with the balance (i.e., about 70% to about 5%) being the water-soluble solvent. Preferred compositions contain about 60% to about 95% water, based on the total weight of the aqueous vehicle.

The amount of aqueous vehicle in the ink is in the range of about 70% to about 99.8%, preferably about 80% to about 99.8%, based on total weight of the ink.

Proportion of Main Ingredients

The CuPc pigment levels employed in the instant inks are those levels which are typically needed to impart the desired color density to the printed image. Typically, CuPc is present at a level of about 0.1% up to a level of about 8% by weight of the total weight of ink. A cyan ink for photo printing will typically comprise 1.5-2.5% CuPc. Usually, the cyan CuPc will be the only pigment colorant in the ink. However, in some cases, it may be desirable to make a shade of ink where CuPc is combined with other pigments.

The polyurethane level employed is dictated by the degree of bronzing reduction sought and the range of ink properties that can be tolerated. Generally, polyurethane levels will range up to about 10%, more particularly from about 0.1% up to about 10%, and typically about 0.2% to about 5%, by weight (polyurethane solids basis) of the total weight of ink.

Effective levels of PUD are typically those where the weight ratio of pigment to PUD (solids) is less than about 2.5, preferably less than about 2.0 and even more preferably less than about 1.5. Generally, greater reduction in bronzing is obtained at lower ratios, but this has to be balanced against other ink properties, such as viscosity, to maintain acceptable jetting performance. The right balance of properties must be determined for each circumstance.

Combinations of two or more polyurethane dispersions may also be utilized.

Other Ingredients

The inkjet ink may contain other ingredients as are well known in the art. For example, anionic, nonionic, cationic or amphoteric surfactants may be used. In aqueous inks, the surfactants are typically present in the amount of about 0.01 to about 5%, and preferably about 0.2 to about 2%, based on the total weight of the ink.

Co-solvents, such as those exemplified in U.S. Pat. No. 5,272,201 (incorporated by reference herein for all purposes as if fully set forth) may be included to improve pluggage inhibition properties of the ink composition.

Biocides may be used to inhibit growth of microorganisms.

Sequestering agents such as EDTA may also be included to eliminate deleterious effects of heavy metal impurities.

Other known additives may also be added to improve various properties of the ink compositions as desired. For example, penetrating agents such as glycol ethers and 1,2-alkanediols may be added to the formulation.

Glycol ethers include ethylene glycol monobutyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-n-butyl ether, triethylene glycol mono-n-butyl ether, diethylene glycol mono-t-butyl ether, 1-methyl-1-methoxybutanol, propylene glycol mono-t-butyl ether, propylene glycol mono-n-propyl ether, propylene glycol mono-iso-propyl ether, propylene glycol mono-n-butyl ether, dipropylene glycol mono-n-butyl ether, dipropylene glycol mono-n-propyl ether, and dipropylene glycol mono-iso-propyl ether.

1,2-Alkanediols are preferably 1,2-alkanediols having 2 to 6 carbon atoms, most preferably 1,2-hexanediol.

The amount of glycol ether(s) and 1,2-alkanediol(s) added must be properly determined, but is typically in the range of from about 1 to about 15% by weight and more typically about 2 to about 10% by weight, based on the total weight of the ink.

Ink Properties

Jet velocity, separation length of the droplets, drop size and stream stability are greatly affected by the surface tension and the viscosity of the ink. Pigmented inkjet inks suitable for use with ink jet printing systems should have a surface tension in the range of about 20 dyne/cm to about 70 dyne/cm, more preferably about 25 to about 40 dyne/cm at 25° C. Viscosity is preferably in the range of about 1 cP to about 30 cP, more preferably about 2 to about 20 cP at 25° C. The ink has physical properties compatible with a wide range of ejecting conditions, i.e., driving frequency of the pen and the shape and size of the nozzle. The inks should have excellent storage stability for long periods. Further, the ink should not corrode parts of the inkjet printing device it comes in contact with, and it should be essentially odorless and non-toxic. Preferred inkjet printheads include those with piezo and thermal droplet generators.

Inks of the instant invention can achieve the beneficial image properties of high OD, water and smear resistance, in a formulation of relatively low viscosity, e.g. less than about 5 cps (Brookfield viscometer with a LVT adapter at 20° C.), although no particular limitation on viscosity is implied.

Inks of the instant invention generally are storage stable. Thus, the instant inks can sustain elevated temperature in a closed container for extended periods (e.g. 60° C. for 7 days) without substantial increase in viscosity or particle size.

Evaluation

The inks were evaluated by printing onto Epson Photoglossy Paper (# S041286) with an Epson Stylus 980 printer at 2880 dpi.

The test pattern to assess bronzing was a block 10×15 cm in dimension and 100% coverage. Bronzing was graded as the degree of red (or pink) reflection from the printed surface. This reflection was best viewed under fluorescent lighting at approximately 60 degrees with the print held normal to the light source, although the bronzing effect is evident under most common light sources at many angles.

The following scale was used:

0=severe bronzing.

1=moderate bronzing.

2=slight bronzing.

3=very slight bronzing.

4=substantially no bronzing.

The test pattern to assess gloss uniformity consisted of 1″×1″ color blocks at 20, 40, 60, 80 and 100% area fill. The gloss was measured at 200 and 600 for each block. The gloss measurements were made with a Byk-Gardner Micro-TRI gloss instrument. Uniformity was judged from the standard deviation (std. dev.) across fill areas—lower std. dev. indicating higher uniformity.

Preparation of Cyan Pigment Dispersion

A cyan dispersion was prepared by first mixing well the following ingredients: (i) 15.86 parts by weight (pbw) deioinized water, (ii) 9.62 pbw of a 39.0% solids anionic polymeric dispersant, (iii) 8.48 pbw of a 44.2% solids nonionic polymeric dispersant, and (iv) 1.04 pbw of dimethylethanolamine. To this was gradually added 15 pbw cyan pigment (pigment blue 15:3). After the pigment was incorporated, 38.24 pbw deionized water was mixed in to form the millbase, which was circulated through a media mill for grinding. 11.51 pbw deionized water and 0.25 pbw biocide (Proxell™ GXL, Avecia) were then added for dilution to final strength (100 pbw total).

The resulting 15 wt % dispersion had the following properties: a viscosity of 6.9 cP (Brookfield viscometer, 20° C.), a pH of about 8.5 and a median particle size of 92 nm. The anionic polymer dispersant was a block co-polymer 13 BzMA/10 MM and the nonionic dispersant was a graft co-polymer 40/30-g-30 BzMA/ETEGMA-g-MPEG 1000 (BzMA=benzylmethacrylate; MMA=methylmethacrylate; ETEGMA−ethoxytriethylenglycolmethacrylate; MPEG=methoxypolyethyleneglycol methacrylate).

Polyurethane Ingredients and abbreviations:

DMPA=dimethylol propionic acid

IPDI=isophoronediisocyanate

TEA=triethylamine

APTES=aminopropyltriethoxysilane

EDA=ethylene diamine

DMEA=dimethylethanolamine

NMP=n-Methyl pyrolidone

IPDA=isophoronediamine

DBTL=dibutyltindilaurate

Nacol® 12-96=96.5+% 1-dodecanol (Condea Chemie GmbH)

HEMA—hydroxyethyl methacrylate

DMIPA—dimethyl-2-propanol amine

APTMS—aminopropyltrimethoxy silane

MMA—methyl methacrylate

Wako VA 086=Initiator made by Wako Inc.

tBA=tert. butylacrylate

HDDA=hexandioldiacrylate

nBA=n-butylacrylate

Polycarbonate Diol_=(1,6-hexanediol polycarbonate), OH # 63.25 mg KOH/gram

Polyester Diol 1=ester of 25.03 parts isononic acid, 32.65 parts cyclohexandicarboxylic acid (CHDA), 42.22 parts trimethylolpropane (TMP) 00.10 parts sulfonic acid ester (catalyst)

Polyester Diol 2=(ethylene glycol, adipic acid and isophthalic acid copolymer); OH # 106 mg KOH/gram

Polyurethane dispersion 1 (PUD 1)

To a dry, alkali- and acid-free flask, equipped with an addition funnel, a condenser, stirrer and a nitrogen gas line was added 439.90 g Desmophene C 200 (Bayer), 88.20 g acetone and 0.06 g DBTL. The contents were heated to 40° C. and mixed well. 146.60 g IPDI was then added to the flask via the addition funnel at 40° C. over 60 min, with any residual IPDI being rinsed from the addition funnel into the flask with 21.80 g acetone.

The flask temperature was raised to 50° C., held for 30 minutes then cooled to 30° C. 60.60 g of APTES, followed by 22.20 g DMPA, then followed by 17.76 g TEA, was added to the flask via the addition funnel, which was then rinsed with 8.34 g acetone. The flask temperature was then raised again to 50° C. and held for 60 minutes.

With the temperature at 50° C., 1044.80 g deionized (DI) water was added over 10 minutes, followed by 120.00 g EDA (as a 6.25% solution in water) over 5 minutes, via the addition funnel, which was then rinsed with 107.53 g water. The mixture was held at 50° C. for 1 hr, then cooled to room temperature.

Acetone (−118.34 g) was removed under vacuum, leaving a final dispersion of polyurethane with about 35.5% solids by weight.

Polyurethane Dispersion 2 (PUD 2)

To a dry alkali- and acid-free flask, equipped with an addition funnel, a condenser, stirrer and a nitrogen gas line, was added 467.01 g of Desmophene C 200 (Bayer), 120.03 g acetone and 0.07 g DBTL. The contents were heated to 40° C. and mixed well. 155.61 g IPDI was then added to the flask via the addition funnel over 60 min, with any residual IPDI being rinsed from the addition funnel into the flask with 23.32 g acetone.

The flask temperature was raised to 50° C. and held for 30 minutes. 23.49 g DMPA followed by 15.05 g TEA was then added to the flask via the addition funnel, which was then rinsed with 4.32 g of acetone. The flask temperature was then held at 50° C. for 60 minutes.

With temperature at 50° C., 573.63 g Dl water was added over 10 minutes, followed by 280.5 g EDA (as a 6.25% solution in water) over 5 minutes, via the addition funnel, which was then rinsed with 2.90 g of water. The mixture was then held at 50° C. for 1 hr, then cooled to room temperature.

Acetone (−147.67 g) was removed under vacuum, leaving a final dispersion of polyurethane with about 40% solids by weight.

Polyurethane Dispersion 3 (PUD 3)

To a dry, alkali- and acid-free flask, equipped with an addition funnel, a condenser, stirrer and a nitrogen gas line was added 137.42 g IPDA, 203.62 g acetone and 33.08 g DMPA. The contents were heated to 60-65° C. for 6 hours with mixing. 619.81 g Polyester Diol 1 and 24.26 g IPDI were then added to the flask, with heating and mixing continued until the NCO number was less than 0.3%. The contents were then cooled to 50° C., and 12.36 g DMEA and 3.90 g IPDA were added to the flask and the contents mixed for another 30 minutes. 1205.55 g DI water was then added over 10 minutes to invert the polymer.

Acetone (−203.00 g) was removed under vacuum, and the temperature of the flask was allowed to rise to 75-80° C. The solids were checked and adjusted to 40.0% with DI water.

Polyurethane Dispersion 4 (PUD 4)

Prepolymer Preparation. To a dry, alkali- and acid-free flask, equipped with an addition funnel, condenser, stirrer and a nitrogen gas line was added 553.504 g Polyester Diol 2, which was heated to 50-60° C. and mixed well. The temperature was Increased to 85-90° C., the 64.99 g DMPA and 302.08 g NMP were added.

The contents were held until visually clear (ca. 4-5 hours), then the temperature was reduced to 50° C. and 287.872 g IPDI added. The temperature was raised to 85° C. and held until NCO % was 1.9-2.1 (ca. 4-6 hours).

The batch was cooled to 80° C., and a combined solution of 24.29 g Nacol 12-96, 6.75 g HEMA and 0.288 g DBTL was added over thirty (30) minutes. The mixture was held at 62° C. until NCO % was 1.3-1.5 (ca. 3 hours).

With the temperature at 62° C., a solution of 74.63 g of APTES and 6.656 NMP was added in 3 portions, over 30 minutes, while controlling the temperature. 302.08 g MMA was then added at 70° C. over 10 minutes, and the temperature held at 70° C. until NCO % was ≦0.33.

The mixture was then cooled to 55-65° C., and 26.4 grams of a 50% solution of DMIPA in water was added over 10 minutes, followed by the addition of 1526.88 g water over 15 minutes. The total was 1991.55 g of prepolymer solution with a solids content of 30.9% and an MEQ-Amine of 26.

Final Polymer. To a dry flask equipped with an addition funnel, condenser, stirrer and a nitrogen gas line, was add 1415.87 g of the prepolymer solution formed above, 16.00 g butylglycol, 22.11 g of a DMIPA/water (1:1) solution and 267.20 g DI water at ambient temperature. While stirring, the mixture was heated to 80-85° C. for 3-4 hours.

At 80-85° C., a solution of Wako VA (1.89 g in 94.14 g DI water) was added over 10 minutes. Simultaneously, the addition of a solution of 235.97 g tBA, 35.42 g HDDA, 436.67 g nBA and 3.78 g Wako VA 086 in 480.0 g water, was begun and continued over a period of 4 hours. 190.94 g DI water was then added to adjust solids, and the mixture held at 80° C. for 3 hours.

Total polyurethane dispersion recovered was 3200 g, with a solids content of 40.6%, an MEQ-Amine of 16, a GPC (THF) Mw≧1,000,000, an NMP of ca. 4.2%, and an average particle size of 103 nm.

Polyurethane Dispersion 5 (PUD 5)

To a dry, alkali- and acid-free flask, equipped with an addition funnel, a condenser, stirrer and a nitrogen gas line, was added 12.46 g DMPA, 95.14 g NMP and 227.57 g polyester diol 2. The contents were heated to 50-65° C. and mixed well.

85.47 g IPDI was then added to the flask via the addition funnel at 50-65° C. over 10-15 min, with any residual IPDI being rinsed from addition funnel into the flask with 13.30 g NMP.

The flask temperature was raised to 75° C., held for 3-4 hours then cooled to below 30° C., at which time 8.65 g of a neutralizing amine (dimethylamino 2-propanol) was added.

447.06 g water was then added to invert the resin, and 3.80 g EDA was added via the addition funnel as a chain extender, with any residual EDA being rinsed from the addition funnel into the flask with 27.90 g water.

The contents were then heated 40° C. and stirred for 1 hr, the cooled to room temperature, leaving a final dispersion of polyurethane with about 40.0% solids by weight.

Preparation of Inks

Inks were made according to the following recipes. Ingredient amounts are in weight percent of the final ink; binders are quoted on a polyurethane solids basis. The viscosity (Brookfield viscometer) in all cases was about 4 cP at 25° C. The bronzing rating and gloss results are also noted for each.

| | Ink Example | | | | | |
|---|---|---|---|---|---|---|
| | A | | | | | |
| | Comp. | 1 | 2 | 3 | 4 | 5 |
| Cyan dispersion | 1.5% | 1.5% | 1.5% | 1.5% | 1.5% | 1.5% |
| (% pigment) | | | | | | |
| PUD 1 | — | 1% | 1.5% | 2% | — | — |
| PUD 2 | — | — | — | — | 1% | — |
| PUD 3 | — | — | — | — | — | 1% |
| 1,2-Hexanediol | 3% | 3% | 3% | 3% | 3% | 3% |
| 2-P | 3% | 3% | 3% | 3% | 3% | 3% |
| Triethylene Glycol Mono- | 5% | 5% | 5% | 5% | 5% | 5% |
| butyl Ether | | | | | | |
| Glycerol | 20.7% | 19.4% | 18.5% | 17.7% | 18.5% | 18.4% |
| Ethylene Glycol | 2% | 2% | 2% | 2% | 2% | 2% |
| Triethanol amine | 0.5% | 0.5% | 0.5% | 0.5% | 0.5% | 0.5% |
| BYK 348 | 0.5% | 0.5% | 0.5% | 0.5% | 0.5% | 0.5% |
| Water (to 100%) | balance | balance | balance | balance | balance | balance |
| 20° Gloss (100% fill) | 85.5 | 66.7 | 57.1 | 60.9 | 47.8 | 63.8 |
| 60° Gloss (100% fill) | 106.1 | 90.7 | 88.7 | 89.8 | 106.0 | 93.6 |
| Pigment/PUD weight ratio | — | 1.5 | 1.0 | 0.75 | 1.5 | 1.5 |
| Bronzing Rating | 0 | 2 | 4 | 4 | 3 | 1 |

| | Ink Example | | | | |
|---|---|---|---|---|---|
| | B | | | | |
| | Comp. | 6 | 7 | 8 | 9 |
| Cyan dispersion | 5.0% | 5.0% | 5.0% | 5.0% | 5.0% |
| (% pigment) | | | | | |
| Glycerol | 8.0% | 2.0% | 2.0% | 0.0% | 5.0% |
| Ethylene Glycol | 2.0% | 2.0% | 2.0% | 2.0% | 2.0% |
| 1,2-Hexanediol | 3.00% | 3.00% | 3.00% | 3.00% | 3.00% |
| Triethlene glycol | 5.0% | 5.0% | 5.0% | 5.0% | 5.0% |
| Monobutyl ether | | | | | |
| 2-Pyrrolidone | 3.0% | 3.0% | 3.0% | 3.0% | 3.0% |
| EDTA | 0.05% | 0.05% | 0.05% | 0.05% | 0.05% |
| Triethanolamine | 0.5% | 0.5% | 0.5% | 0.5% | 0.5% |
| BYK-348 | 0.5% | 0.5% | 0.5% | 0.5% | 0.5% |
| PUD 4 | — | 4.0% | — | — | — |
| PUD 1 | — | — | 4.0% | — | — |
| PUD 5 | — | — | — | 4.0% | 2.0% |
| Proxel GXL | 0.2% | 0.2% | 0.2% | 0.2% | 0.2% |
| DI Water | balance | balance | Balance | balance | balance |
| OD* | 1.05 | 1.12 | 1.11 | 1.1 | 1.06 |
| Chroma* | 46.09 | 48.73 | 50.29 | 48.72 | 49.46 |
| 20′ gloss | 59.6 | 20.8 | 24 | 26.4 | 30.2 |
| pigment/PUD weight | — | 1.25 | 1.25 | 1.25 | 2.5 |
| ratio | | | | | |
| Bronzing | 0 | 1 | 1 | 1 | 0 |

*OD and Chroma tests printed with Epson C80 (720 dpi) on Xerox 4024 plain paper, 100% fill, measured with a Gretag-Macbeth Spectro Eye

Results of inventive Examples 1-9 versus Comparative Examples A and B demonstrate that including polyurethane dispersion reduces bronzing of the printed ink. Choice of PUD and weight percent thereof can be optimized to achieve maximum effect.

A certain amount of PUD relative to pigment, expressed as pigment/PUD weight ratio, is preferred to provide better bronzing reduction. In Examples 1-5, with the proper amount of PUD, bronzing can be substantially eliminated.

Sometimes, a denser cyan is desired and more pigment is included in the ink. At higher pigment loadings, Examples 6-9, it may be difficult to incorporate (because of upper viscosity limits of the printer) enough PUD to completely eliminate bronzing, although bronzing is still reduced significantly. However, PUD levels that reduce bronzing are also shown to increase optical density. Iteration on pigment/PUD ratios will yield the best ratio for a given optical density target. For comparison, a commercial, cyan pigment ink was evaluated for bronzing. Epson 2000P cyan ink, printed on Epson Premium Glossy S041286 Paper, showed a bronzing ‘0’ on the rating scale. Thus, the inventive inks provide a substantially improved—lower bronzing—cyan pigment ink compared to a current commercial standard.

Gloss uniformity results are summarized in the following tables.

| Ink A | % Fill | 20° Gloss |
|---|---|---|
| | 100% | 84.3 |
| | 80% | 91.4 |
| | 60% | 86.0 |
| | 40% | 50.5 |
| | 20% | 29.8 |
| (Std. dev.) | | (26.93) |
| Ink 2 | % Fill | 20° Gloss |
| | 100% | 61.2 |
| | 80% | 59.6 |
| | 60% | 56.2 |
| | 40% | 43.3 |
| | 20% | 49.4 |
| (std. dev.) | | (7.48) |
| Ink 3 | % Fill | 20° Gloss |
| | 100% | 55.8 |
| | 80% | 55.8 |
| | 60% | 57.4 |
| | 40% | 36.2 |
| | 20% | 39.6 |
| (std. dev.) | | (10.19) |
| Ink 4 | % Fill | 20° Gloss |
| | 100% | 48.7 |
| | 80% | 52.3 |
| | 60% | 43.4 |
| | 40% | 61.3 |
| | 20% | 57.2 |
| (Std dev) | | (7.01) |
| Ink 5 | % Fill | 20° Gloss |
| | 100% | 61.9 |
| | 80% | 64.9 |
| | 60% | 52.2 |
| | 40% | 79.1 |
| | 20% | 58.1 |
| (std. dev.) | | (10.05) |

This data demonstrates that the inventive inks improve gloss uniformity, in other words, the variation in gloss across different area fills is more uniform (lower standard deviation) compared to control ink A.

We claim:

1. An aqueous inkjet ink comprising an aqueous vehicle having dispersed therein (1) a cyan copper phthalocyanine pigment and (2) a polyurethane, provided that:
(i) the cyan copper phthalocyanine pigment is not dispersed in the aqueous vehicle by a sodium aromaticsulfonate-formaldehyde condensate dispersant; and/or
(ii) the weight ratio of cyan copper phthalocyanine pigment to polyurethane is less than about 2.5.

2. The aqueous inkjet ink of claim 1, wherein (i) the cyan copper phthalocyanine pigment is not dispersed in the aqueous vehicle by a sodium aromaticsulfonate-formaldehyde condensate dispersant; and (ii) the weight ratio of cyan copper phthalocyanine pigment to polyurethane is less than about 2.5.

3. The aqueous inkjet ink of claim 1, wherein the weight ratio of cyan copper phthalocyanine pigment to polyurethane is less than about 1.5.

4. The aqueous inkjet ink of claim 1, wherein the pigment is PB 15:3 or PB 15:4.

5. The aqueous inkjet ink of claim 1, wherein the polyurethane is dispersed in the aqueous vehicle as an anionically stabilized polyurethane dispersion.

6. The aqueous inkjet ink of claim 1, wherein the cyan copper phthalocyanine pigment is a self-dispersing pigment.

7. The aqueous inkjet ink of claim 1, wherein the cyan copper phthalocyanine pigment is dispersed in the aqueous vehicle with a polymeric dispersant.

8. The aqueous inkjet ink of claim 1, comprising from about 70% to about 99.8% aqueous vehicle, from about 0.1 to about 8% cyan copper phthalocyanine pigment, and about 0.1 to about 10% polyurethane (solids), based on the total weight of the ink.

9. The aqueous inkjet ink of claim 1, having a surface tension in the range of about 20 dyne/cm to about 70 dyne/cm at 25° C., and a viscosity in the range of about 1 cP to about 30 cP at 25° C.

10. An aqueous inkjet ink comprising a mixture of (1) an aqueous vehicle, (2) a cyan copper phthalocyanine pigment and (3) a polyurethane dispersion, such that the pigment and polyurethane are dispersed in the aqueous vehicle, provided that:
(i) the cyan copper phthalocyanine pigment is not dispersed in the aqueous vehicle by a sodium aromaticsulfonate-formaldehyde condensate dispersant; and/or
(ii) the weight ratio of cyan copper phthalocyanine pigment to polyurethane is less than about 2.5.

11. The aqueous inkjet ink of claim 10, wherein (i) the cyan copper phthalocyanine pigment is not dispersed in the aqueous vehicle by a sodium aromaticsulfonate-formaldehyde condensate dispersant; and (ii) the weight ratio of cyan copper phthalocyanine pigment to polyurethane is less than about 2.5.

12. The aqueous inkjet ink of claim 10, wherein the weight ratio of cyan copper phthalocyanine pigment to polyurethane is less than about 1.5.

13. The aqueous inkjet ink of claim 10, wherein the pigment is PB 15:3 or PB 15:4.

14. The aqueous inkjet ink of claim 10, wherein the polyurethane is dispersed in the aqueous vehicle as an anionically stabilized polyurethane dispersion.

15. The aqueous inkjet ink of claim 10, wherein the cyan copper phthalocyanine pigment is a self-dispersing pigment.

16. The aqueous inkjet ink of claim 10, wherein the cyan copper phthalocyanine pigment is dispersed in the aqueous vehicle with a polymeric dispersant.

17. The aqueous inkjet ink of claim 10, comprising from about 70% to about 99.8% aqueous vehicle, from about 0.1 to about 8% cyan copper phthalocyanine pigment, and about 0.1 to about 10% polyurethane (solids), based on the total weight of the ink.

18. The aqueous inkjet ink of claim 10, having a surface tension in the range of about 20 dyne/cm to about 70 dyne/cm at 25° C., and a viscosity in the range of about 1 cP to about 30 cP at 25° C.

19. An inkjet ink set for color printing, comprising a cyan, magenta and yellow ink, wherein the cyan ink comprises an aqueous vehicle having dispersed therein (1) a cyan copper phthalocyanine pigment and (2) a polyurethane, provided that:
(i) the cyan copper phthalocyanine pigment is not dispersed in the aqueous vehicle by a sodium aromaticsulfonate-formaldehyde condensate dispersant; and/or
(ii) the weight ratio of cyan copper phthalocyanine pigment to polyurethane is less than about 2.5.

20. An inkjet ink set for color printing, comprising a cyan, magenta and yellow ink, wherein the cyan ink comprises a mixture of (1) an aqueous vehicle, (2) a cyan copper phthalocyanine pigment and (3) a polyurethane dispersion, such that the pigment and polyurethane are dispersed in the aqueous vehicle, provided that:
(i) the cyan copper phthalocyanine pigment is not dispersed in the aqueous vehicle by a sodium aromaticsulfonate-formaldehyde condensate dispersant; and/or
(ii) the weight ratio of cyan copper phthalocyanine pigment to polyurethane is less than about 2.5.
